(19) United States
(12) Patent Application Publication
(10) Pub. No.: US 2003/0146027 A1
(43) Pub. Date: Aug. 7, 2003

(54) Residual power indicator for a storage battery of an electric-powered vehicle

(76) Inventors: Tung-Shiang Yu, Taipei City (JP); Ian Chen, Taichung Hsien (TW)

Correspondence Address: HARNESS, DICKEY & PIERCE, P.L.C., P.O. BOX 828, BLOOMFIELD HILLS, MI, 48303, US

(21) Appl. No.: 10/071,922

(22) Filed: Feb. 7, 2002

(51) Int. Cl. B60K 6/00; B60K 1/00

(52) U.S. Cl. 180/65.2; 180/68.5

(57) ABSTRACT

A residual power indicator includes a current detector for monitoring current consumption of a storage battery, and a processor unit for calculating consumed power of the storage battery. The processor unit includes a memory device for recording a reference value corresponding to the residual power of the storage battery. The reference value in the memory device is periodically updated by the processor unit to reflect actual residual power of the storage battery. A display unit is controlled by the processor unit so as to provide a visual indication corresponding to the reference value in the memory device.

### BACKGROUND OF THE INVENTION

1. Field of the Invention

The invention relates to a power indicator, more particularly to a residual power indicator for a storage battery of an electric-powered vehicle.

2. Description of the Related Art

In a conventional method for indicating residual power of a storage battery used in an electric-powered vehicle, the battery voltage is measured and is shown directly on a display. While this method involves a relatively low cost, due to the characteristics of batteries, even though a lot of electric power has been consumed during a previous operation, after a relatively long idle time period has elapsed, the battery voltage will rise to a relatively high level that can result in erroneous close-to-full-power indication.

Another conventional method for indicating residual power involves the use of an ampere-hour meter. While the ampere-hour meter is very accurate, it is relatively expensive.

### SUMMARY OF THE INVENTION

Therefore, the object of the present invention is to provide a relatively low cost and highly accurate residual power indicator for a storage battery.

Accordingly, the residual power indicator of this invention is adapted for use with a storage battery in an electric-powered vehicle, and comprises a current detector, a processor unit and a display unit. The current detector is adapted to monitor current consumption of the storage battery. The processor unit is connected to the current detector, and is operable so as to calculate consumed power of the storage battery as a function of both time and the current consumption monitored by the current detector. The processor unit includes a memory device for recording a reference value corresponding to the residual power of the storage battery. The reference value in the memory device is periodically updated by the processor unit to reflect actual residual power of the storage battery. The display unit is connected to and is controlled by the processor unit so as to provide a visual indication corresponding to the reference value in the memory device.

### BRIEF DESCRIPTION OF THE DRAWINGS

Other features and advantages of the present invention will become apparent in the following detailed description of the preferred embodiment with reference to the accompanying drawing, of which:

FIG. 1 is a block diagram illustrating an electric-powered vehicle that incorporates the preferred embodiment of a residual power indicator according to the present invention.

### DETAILED DESCRIPTION OF THE PREFERRED EMBODIMENT

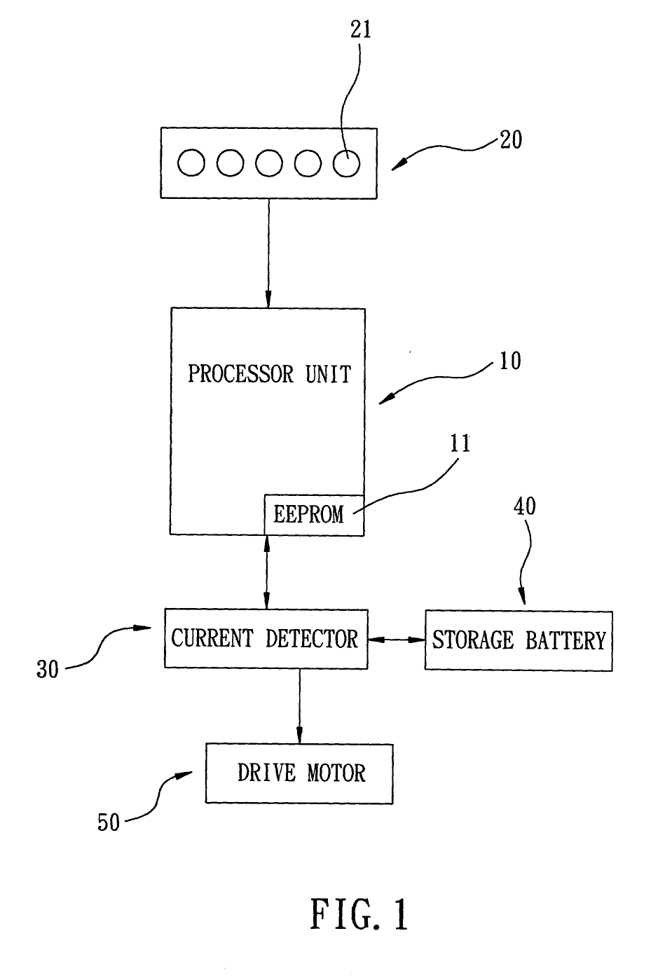

FIG. 1 illustrates an electric-powered vehicle that incorporates the preferred embodiment of a residual power indicator according to the present invention. The vehicle includes a rechargeable storage battery 40 and a drive motor 50 coupled to the storage battery 40. The residual power indicator comprises a current detector 30, a processor unit 10 and a display unit 20.

The current detector 30 is connected to the processor unit 10, the storage battery 40 and the drive motor 50. The current detector 30 is operable so as to start operation of the drive motor 50 under the control of the processor unit 10, and so as to monitor the current consumption of the storage battery 40.

The processor unit 10 is operable so as to calculate consumed power of the storage battery 40 as a function of both time and the current consumption monitored by the current detector 30. The processor unit 10 includes a memory device 11, such as an electrically erasable programmable read-only memory (EEPROM), that stores a control program for the processor unit 10. The processor unit 10 records a reference value corresponding to the residual power of the storage battery 40 in the memory device 11. The reference value in the memory device 11 is periodically updated by the processor unit 10 to reflect actual residual power of the storage battery 40.

The display unit 20 is connected to and is controlled by the processor unit 10 so as to provide a visual indication corresponding to the reference value in the memory device 11. In this embodiment, the display unit 20 includes five light emitting diodes 21. The processor unit 10 activates a number of the diodes 21 that corresponds to percentage of the residual power based on full power of the storage battery 40.

In use, when a power switch (not shown) of the vehicle is turned on, the processor unit 10 will be enabled to start operation of the drive motor 50. Thereafter, the processor unit 10 will begin calculating the consumed power of the storage battery 40 as a function of both time and the current consumption monitored by the current detector 30. The reference value corresponding to the residual power of the storage battery 40 is stored in the memory device 11, and is periodically updated by the processor unit 10 so that the actual residual power of the storage battery 40 can be shown on the display unit 20. The greater the residual power, the greater will be the number of the activated diodes 21. In this embodiment, the diodes 21 are deactivated one-by-one each time a 20% drop in residual power is detected. When the power switch of the vehicle is turned off, the latest reference value corresponding the actual residual power of the storage battery 40 will be stored in the memory device 11, and will be referred to by the processor unit 10 so that the correct state of the storage battery 40 can be indicated to the user during a subsequent power-on activity.

When the vehicle is turned on after charging of the battery 40 has been conducted, the processor unit 10 will automatically operate in an initializing mode, where the processor unit 10 enables the current detector 30 to further detect the battery voltage of the storage battery 40 in the event that the latest reference value stored in the memory device 11 indicates that the residual power of the storage battery 40 is lower than 80% based on full power of the storage battery 40. Thereafter, when the battery voltage detected by the current detector 30 is greater than a preset high voltage, the processor unit 10 updates the reference value in memory device 11 to indicate full power.

Because the processor unit 10 is used to calculate the consumed power of the storage battery 40, the result provided by the indicator of this invention is highly accurate. In addition, because an electric-powered vehicle generally includes a processor that can be suitably configured via software to result in the residual power indicator of this invention, the hardware cost for implementing the present invention is relatively low. Moreover, because the display unit 20 is controlled by the processor unit 10 according to latest residual power data stored in the memory device 11, the accuracy of the residual power indicator can be ensured.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A residual power indicator for a storage battery, comprising:
a current detector adapted to monitor current consumption of the storage battery;
a processor unit connected to said current detector and operable so as to calculate consumed power of the storage battery as a function of both time and the current consumption monitored by said current detector, said processor unit including a memory device for recording a reference value corresponding to the residual power of the storage battery, the reference value in said memory device being periodically updated by said processor unit to reflect actual residual power of the storage battery; and
a display unit connected to and controlled by said processor unit so as to provide a visual indication corresponding to the reference value in said memory device.

2. The residual power indicator as claimed in claim 1, wherein said display unit includes a plurality of light emitting diodes, said process or unit activating a number of said light emitting diodes that corresponds to percentage of the residual power based on full power of the storage battery.

3. The residual power indicator as claimed in claim 2, wherein said display unit includes five of said light emitting diodes.

4. The residual power indicator as claimed in claim 1, wherein said memory device is an electrically erasable programmable read-only memory.

5. The residual power indicator as claimed in claim 1, wherein said processor unit is operable in an initializing mode, where said processor unit enables said current detector to further detect battery voltage of the storage battery when the reference value in said memory device indicates that the residual power of the storage battery is lower than a preset percentage based on full power of the storage battery, and updates the reference value in said memory device to indicate full power when the battery voltage detected by said current detector is greater than a preset voltage.

6. The residual power indicator as claimed in claim 5, wherein the preset percentage is 80%.

7. An electric-powered vehicle comprising:
a storage battery;
a drive motor coupled to said storage battery; and
a residual power indicator including
a current detector connected to said storage battery and said drive motor for monitoring current consumption of said storage battery,
a processor unit connected to said current detector and operable so as to calculate consumed power of said storage battery as a function of both time and the current consumption monitored by said current detector, said processor unit including a memory device for recording a reference value corresponding to the residual power of said storage battery, the reference value in said memory device being periodically updated by said processor unit to reflect actual residual power of said storage battery, and
a display unit connected to and controlled by said processor unit so as to provide a visual indication corresponding to the reference value in said memory device.

8. The electric-powered vehicle as claimed in claim 7, wherein said display unit includes a plurality of light emitting diodes, said processor unit activating a number of said light emitting diodes that corresponds to percentage of the residual power based on full power of said storage battery.

9. The electric-powered vehicle as claimed in claim 8, wherein said display unit includes five of said light emitting diodes.

10. The electric-powered vehicle as claimed in claim 7, wherein said memory device is an electrically erasable programmable read-only memory.

11. The electric-powered vehicle as claimed in claim 7, wherein said storage battery is a rechargeable battery, and said processor unit is operable in an initializing mode, where said processor unit enables said current detector to further detect battery voltage of said storage battery when the reference value in said memory device indicates that the residual power of said storage battery is lower than a preset percentage based on full power of said storage battery, and updates the reference value in said memory device to indicate full power when the battery voltage detected by said current detector is greater than a preset voltage.

12. The electric-powered vehicle as claimed in claim 11, wherein the preset percentage is 80%.
